(19) United States
(12) Patent Application Publication
(10) Pub. No.: US 2008/0195679 A1
(43) Pub. Date: Aug. 14, 2008

(54) Systems and methods for managing data storage

(75) Inventors: Myoung-Soo Jung, Suwon-si (KR); Se-Jeong Jang, Anyang-si (KR); Chan-Ik Park, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/003,465

(22) Filed: Dec. 26, 2007

(30) Foreign Application Priority Data
Feb. 9, 2007 (KR) 2007-13894

(51) Int. Cl. G06F 12/00

(52) U.S. Cl. 707/205; 707/E17.01; 711/E12.001

(57) ABSTRACT

In one embodiment, the method includes determining in which of a plurality of memory portions to store a received file based on received characterizing information characterizing content of the file. For example, at least two of the plurality of memory portions are in a same memory. As another example, at least two of the plurality of memory portions are in different memories. The received characterizing information may include at least one of a name of the file, a file name extension of the file, a type of the file, and symbolic information representing the file.

### FOREIGN PRIORITY INFORMATION

This application claims priority under 35 U.S.C. 119 on Korean Application No. 2007-13894 filed Feb. 9, 2007; the entire contents of which are hereby incorporated by reference.

### BACKGROUND OF THE INVENTION

The present invention relates to systems and method for managing data storage.

Many different types of storage devices and systems exist. For example, various types of non-volatile storage devices exist. Non-volatile memory retains the data stored therein even when no longer powered. By contrast, volatile memory looses the data stored therein when no longer powered. Dynamic random access memory (DRAM) is an example of volatile memory.

There are many different types of non-volatile memory. Read only memory (ROM), programmable read only memory (PROM), flash memory, electrically erasable programmable read only memory (EEPROM) are examples of solid state memory usually embodied by one or more semiconductor integrated circuit chips. Other types of non-volatile memory include floppy disks, hard disks, optical discs, etc. Different types of non-volatile memory are often characterized by different storage capacities and different access speeds.

Typically, memory is accessed by a computer or processing system. Collectively, these different types of processing systems are referred to as a host system. The host system employs a system, called a file system, for storing and organizing files and the data the files contain. The file system may use one or more types of memory such as discussed above. Accordingly the file system may involve maintaining the physical location of the files stored in the memory. Often, the files system is thought of as a set of abstract data types that are implemented for the storage, hierarchical organization, manipulation, navigation, access, and retrieval of data.

### SUMMARY

The present invention relates to a method of managing data storage.

In one embodiment, the method includes determining in which of a plurality of memory portions to store a received file based on received characterizing information characterizing content of the file. For example, at least two of the plurality of memory portions are in a same memory. As another example, at least two of the plurality of memory portions are in different memories.

The received characterizing information may include at least one of a name of the file, a file name extension of the file, a type of the file, and symbolic information representing the file.

In one embodiment, input/output layer information for storing the received file is generated, and a tag is inserted in the input/output layer to indicate the determined memory portion.

In another embodiment, the method includes receiving input/output information for storing a file. The input/output information includes address information, a command and a tag. The method further includes determining which one of a plurality of memory portions to store the file based on the tag.

The present invention also relates to a system for managing data storage.

In one embodiment, the system includes a memory system and a host system. The memory system includes at least a first memory portion and a second memory portion. The host system determines in which of the first and second memory portions to store a file based on received characterizing information characterizing content of the file.

In yet another embodiment, the system includes a first memory, a second memory, and a host system. The host system determines in which of the first and second memories to store a file based on received characterizing information characterizing content of the file.

The host system may include an input/output layer having a single input/output driver for the first and second memories. The single input/output driver generates input/output information for storing data associated with the file based on the determination of the host system. Alternatively, the host system may include an input/output layer having a first input/output driver for the first memory and a second input/output driver for the second memory. The first and second input/output drivers respectively store data associated with the file based on the determination of the host system.

In another embodiment, a module is disposed between the host system and the second memory. The module includes the first memory and a memory controller. The memory controller receives data associated with the file and an indication of the determination by the host system, and stores the received data in the indicated one of the first and second memories.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a system according to one embodiment of the present invention.

FIG. 2 illustrates a flow chart of a method for managing data storage according to one embodiment of the present invention.

FIG. 3A illustrates one embodiment of a filter driver memory select operation according to the present invention.

FIG. 3B illustrates several symbols used as file names and the characterization of the file.

FIGS. 4A and 4B illustrate example embodiments of where in the I/O layer output the filter driver attaches a tag.

FIGS. 5-6 illustrate another embodiment of a filter driver memory select operation according to the present invention.

FIG. 7 illustrates a further embodiment of a filter driver memory select operation according to the present invention.

FIG. 8 illustrates a flow chart of a method for managing data storage according to another embodiment of the present invention.

FIGS. 9-11 each illustrates a system according to another embodiment of the present invention.

### DETAILED DESCRIPTION OF EXAMPLE EMBODIMENTS

Example embodiments will now be described more fully with reference to the accompanying drawings. However, example embodiments may be embodied in many different forms and should not be construed as being limited to the example embodiments set forth herein. Example embodiments are provided so that this disclosure will be thorough, and will fully convey the scope to those who are skilled in the art. In some example embodiments, well-known processes, well-known device structures, and well-known technologies are not described in detail to avoid the unclear interpretation of the example embodiments. Throughout the specification, like reference numerals in the drawings denote like elements.

It will be understood that when an element or layer is referred to as being “on”, “connected to” or “coupled to” another element or layer, it may be directly on, connected or coupled to the other element or layer, or intervening elements or layers may be present. In contrast, when an element is referred to as being “directly on,” “directly connected to” or “directly coupled to” another element or layer, there may be no intervening elements or layers present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the example embodiments.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-section illustrations that may be schematic illustrations of idealized embodiments (and intermediate structures). As such, variations from the shapes of the illustrations as a result, for example, of manufacturing techniques and/or tolerances, are to be expected. Thus, the example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to limit the example embodiments.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

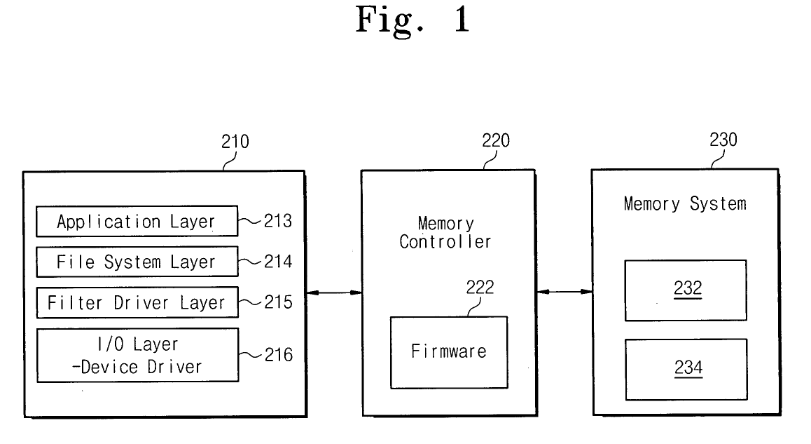

FIG. 1 illustrates a memory system according to one embodiment of the present invention. As shown, a host 210 stores data in and retrieves data from a memory system 230 via a memory controller 220. The memory system 230 may have a memory, a plurality of memories, a portion of a memory, or a plurality of memory portions of at least a first type and a second type. For example, a single memory device may have memory portions or different types as will be discussed in more detail below. In FIG. 1, the memory, memories, portion or portions of the first type will be referred to as a first type of memory 232; and the memory, memories, portion or portions of the second type will be referred to as a second type of memory 234.

The first and second types of memory 232 and 234 may take several different forms. For example, the memory system 230 may be a flash memory system, the first type of memory 232 may be single level cell (SLC), and the second type of memory 234 may be multi-level cell (MLC). As is well-known, an MLC may store more than one bit per memory cell by programming the memory cells to one of a plurality of different threshold states. By contrast, an SLC memory cell stores a single bit. MLCs have a higher data storage capacity, but usually a slower access speed, than SLCs.

As another example, the first type of memory 232 may be a PRAM, FRAM, MRAM, NOR flash or a volatile memory, and the second type of memory 234 may be a NAND flash or other non-volatile memory have slower access speed than the first type of memory 232.

As yet another example, the first type of memory 232 may be flash memory (MLC, SLC or a combination thereof) and the second type of memory 234 may be a hard disk drive. Instead of a hard disk drive, the second type of memory 234 may also be an optical disk drive (e.g., DVD, BD, etc.). As will be appreciated from these examples, the first type of memory 232 has a faster access speed than the second type of memory 234.

The memory controller 220 includes firmware 222. The firmware 222 stores data in a respective one of the first and second types of memory 232 and 234 in response to the host 210. The firmware 222 also retrieves data from a respective one of the first and second types of memory 232 and 234 in response to the host 210.

While physically the host 210 includes one or more processors and local memory for carrying out a variety of functions, conceptually, the host 210 is often described has having several layers in accordance with that functionality. For example, as shown in FIG. 1, the host 210 may include an application layer 213, a file system layer 214, a filter driver layer 215 and an input/output (I/O) layer 216. The application layer 210 is just as its name suggest. This is the layer running applications; for example, a word processing application, a web browsing application, etc. Data is passed from the application layer 213 to the file system layer 214 for storage.

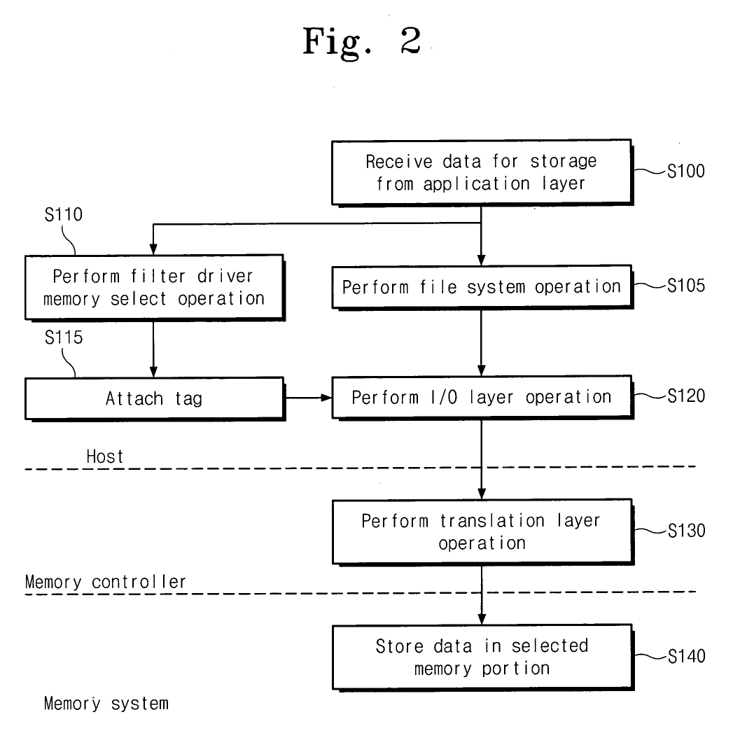

The file system 214 performs a well-known file system operation, which includes generating a logical address in which to store the data. The file system 214 passes the command, logical address and data to the input/output layer 216. The input/output layer 216 includes a device driver for the memory system 230. The device driver formats the command, logical address and data into a format for the memory system 230. The filter driver 215 analyzes information regarding the file to determine in which memory 232 or 234 to store the file, and inserts a tag in the output of the input/output layer 216 that indicates the determined memory. These operations will be discussed in more detail below with respect to FIG. 2.

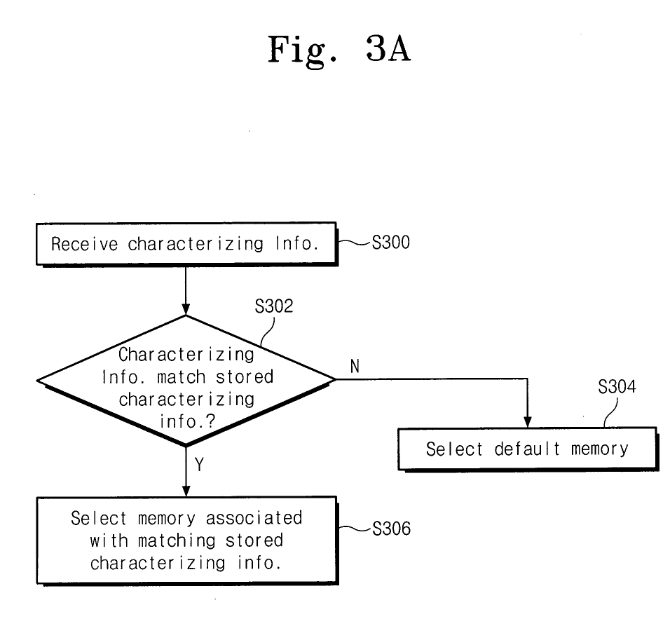

FIG. 2 illustrates a flow chart of a method for managing data storage according to one embodiment of the present invention. This embodiment will be described with reference to FIG. 1 for the purposes of explanation. As shown, the file system layer 214 receives a command to store data and the data from the application layer 213 in step S100. For example, the command may be to “save” a file “name.ext”. Generally, the “.ext” portion of the file is referred to as the file name extension while the “name” portion of the file is the file name. The file extension characterizes the type of file. For example, an extension of “.txt” indicates the file is a text file, an extension of “.pdf” indicates the file is a PDF file, etc. Generally when a file has an extension, the “name” portion of the file does not necessarily characterize the type of file. However, there are files that have no extensions. For these files, the name of the file characterizes the type of file. FIG. 3B illustrates several symbols used as file names and the characterization of the file. FIG. 3B also describes the function of the file. Also, there may be files that are characterized by both the name and the extension. Whether it is the file name, the file extension or both, if this information characterizes the file content, this information may be referred to as characterizing information. Still referring to FIG. 3B, files of the type illustrated therein are referred to as meta data. It will be appreciated that operations involving memory access and storing of data may be directed to file system management such as creating a folder, changing directory information, etc.

Returning to FIG. 2, the file system layer 214, in response to the command, performs a well-known file system operation in step S105. For example, the file system layer 214 follows the file system to generate a logical address for storing the data. Because file systems and file system layer operations are so well-known, this will not be described in detail.

In step S120, the I/O layer 216 performs a well-known I/O layer operation. Namely, a device driver for the memory system 230 formats the command, logical address and data into a format for the memory system 230. This formatted information will be referred to as the I/O layer output or information. The I/O output will be described in more detail below with respect to step S115.

Concurrently with the file system layer operation of step S105, a filter driver memory select operation is performed in step S110. The filter driver memory select operation will be described in detail with respect to FIG. 3A. FIG. 3A illustrates one embodiment of filter driver memory select operation according to the present invention.

As shown in step S300, the filter driver 215 receives the characterizing information for received file. The filter driver 215 stores a table of characterizing information. In the table each characterizing information is associated with one of the first and second types of memory 232 and 234. In step S302, the filter driver 215 determines if the received characterizing information matches one of the stored characterizing information. If not, then in step S304, the filter driver 215 selects a default one of the first and second types of memory 232 and 234. In one embodiment, the default selection is the slower, second type of memory 234.

If the filter driver 215 finds a match in step S302, then the filter driver 215 selects the memory 232 or 234 associated with the stored characterizing information matching the received characterizing information. For example, in one embodiment, characterizing information for meta data may be associated with the first type of memory 232, while characterizing information for other data may be associated with the second type of memory 234. In another embodiment, characterizing information associated with data known to be frequently accessed may be associated with the first type of memory 232 to take advantage of this faster access type of memory.

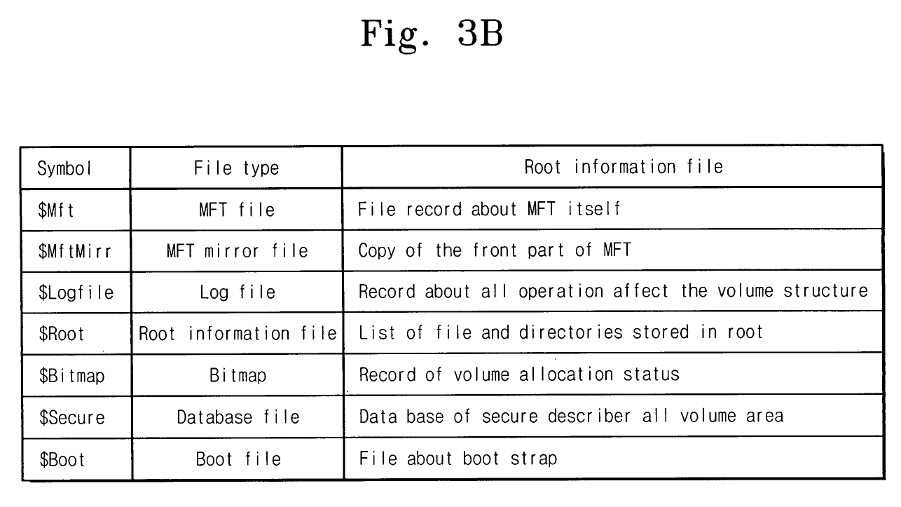

Returning to FIG. 2, in step S115, the filter driver 215 attaches a tag to the I/O layer output. The tag indicates the memory 232 or 234 in which to store the data of the I/O layer output. FIGS. 4A and 4B illustrate example embodiments of where, in the I/O layer output, the filter driver 215 attaches the tag. As shown in FIGS. 4A and 4B, the I/O layer output includes a command section, an address section, and a data section. The command is of a form and type recognized by the memory controller 220 instructing the storage of the data. The address is the logical address generated by the file system 214 in which to store the data, and the data section contains the data to be stored.

As shown in FIG. 4A, the command includes at least an identifier identifying the command and a spare or unused area. In one embodiment, the tag may be inserted into the spare area. As will be appreciated, the tag may depend on the number of memory types in the memory system. For two memory types, the tag may be as short as a single bit. However, for error prevention purposes, multiple redundant bits may be used.

FIG. 4B illustrates an embodiment in which the tag is inserted before the address information in the address section of the I/O layer output. Here, the address section is configured to have a longer than necessary bit length.

Returning to FIG. 2, the firmware 222 performs a translation layer operation on the I/O layer output in step S130. In particular, the firmware 222 translates the logical address in the I/O layer output into a physical address of the memory (memory 232 or 234) indicated by the tag attached to the I/O layer output. The firmware 222 then saves the data in the I/O layer output in the physical address of the memory in response to the command in the I/O layer output in step S140.

As will be appreciated, in this manner, the host 210 may, control in which memory of the memory system 230 data is stored. Furthermore, the host may affect this control without regard to the physical addresses established for the memories of the memory system 230 or the logical addressing of the file system 214.

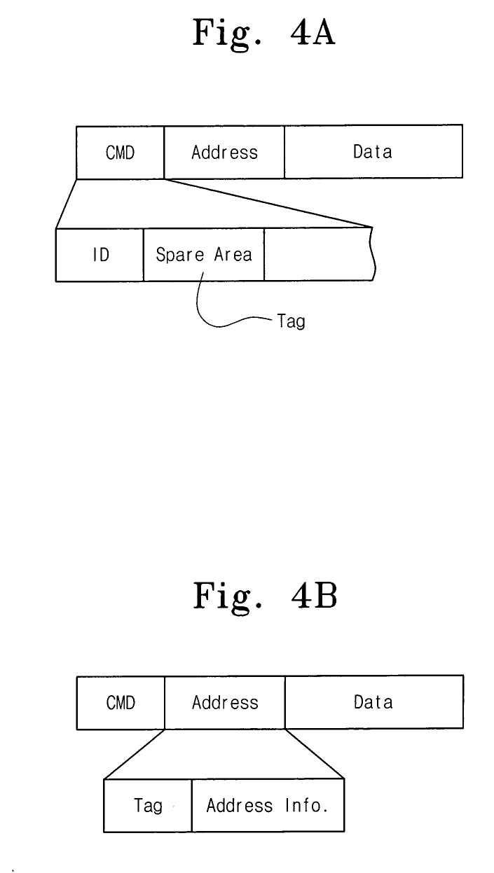

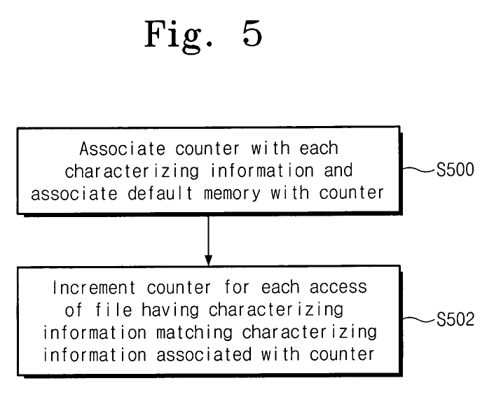

Next, a filter driver memory select operation according to another embodiment of the present invention will be described. In step S110 of FIG. 2, instead of performing the memory select operation of FIG. 3A, the filter driver 215 may perform the memory select operation of FIGS. 5-6.

As shown in FIG. 5, in step S500, the filter driver 215 associates a counter with each characterizing information and associates a default one of the memories in the memory system 230 with the counter. In one embodiment, the default memory is the slower, second type of memory 234. For each access of a file having characterizing information matching characterizing information associated with a counter, the counter is incremented in step S502. An access may constitute storing the file, reading the file, etc.

As shown in FIG. 6, in step S600, the filter driver 215 receives the characterizing information. The filter driver 215 determines whether a counter exists for the characterizing information in step S602. If not, then in step S604, the filter driver 215 selects a default one of the first and second types of memory 232 and 234. In one embodiment, the default selection is the slower, second type of memory 234. Then, in step S606, the filter driver 215 creates and initializes a counter for the received characterizing information, associates the default memory with the counter, and implements the procedure of step S502 for this counter.

Returning to step S602, if a counter exists, then in step S608 the filter driver 215 determines if the counter is greater than a threshold count. If not, then the filter driver 215 selects the memory in the memory system 230 associated with the counter in step S612. If the counter is greater than the threshold, then in step S610, the filter driver 215 associates the faster, first type of memory 232 with the counter. Then, step S612 is performed. The threshold may be empirically determined and set as a fixed value. Alternatively, it is anticipated that various methods of adapting the threshold to operation conditions may be developed.

As will be appreciated, this filter driver memory selection method causes files of a type more frequently accessed to be stored in the memory having faster access speed.

It will also be appreciated that if more than two memory types are included in the memory system 230, then more than one threshold may be employed in the method of FIG. 6 to change the memory associated with a counter.

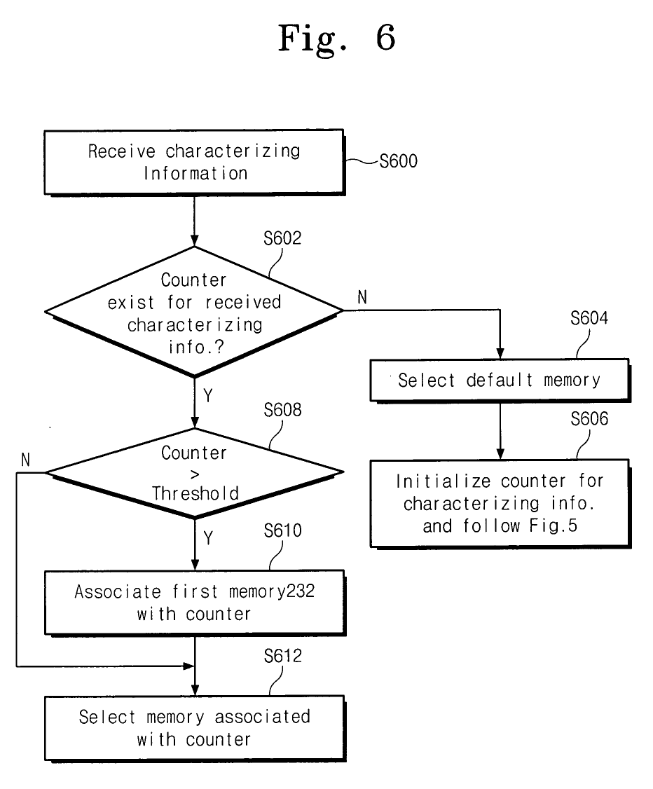

Next, a filter driver memory select operation according to yet another embodiment of the present invention will be described with respect to FIG. 7. In step S110 of FIG. 2, instead of performing the memory select operation of FIG. 3A or FIG. 5, the filter driver 215 may perform the memory select operation of FIG. 7.

As shown in FIG. 7, the memory select operation of FIG. 3A is performed in step S702 and the memory select operation of FIGS. 5-6 is performed in step S704. Then, in step S706, the filter driver 215 selects the faster memory selected in steps S702 and S704.

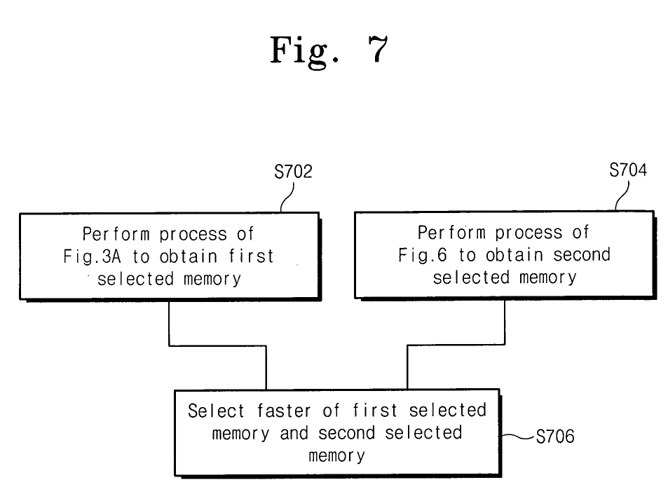

FIG. 8 illustrates a flow chart of a method for managing data storage according to another embodiment of the present invention. The method of FIG. 8 is the same as the embodiment of FIG. 2, except that the filter driver 215 receives the characterizing information from the output of the file system layer operation of step S105.

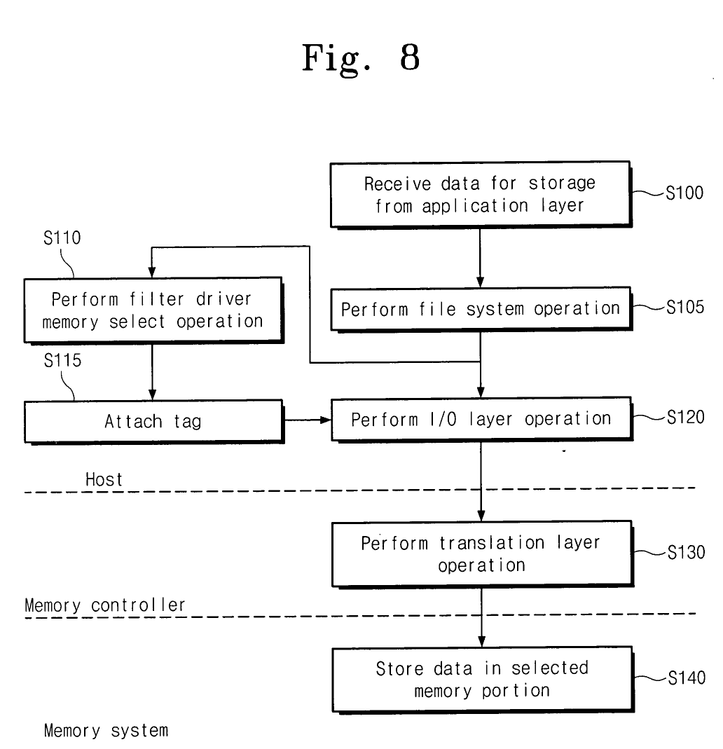

As will be appreciated the methods of managing data storage are not limited in application to the embodiment of FIG. 1. Instead, these methods may be applied to any system employing a memory system of different memory types. FIGS. 9-11 illustrate other embodiments of such systems.

Referring to FIG. 9, the embodiment of FIG. 9 is the same as the embodiment of FIG. 1 except that the memory controller 220 has been eliminated, and the host 210 has been replaced by a host 210′. The host 210′ is the same as the host 210 except that the functions of the memory controller have been included in the host 210′ as represented by the memory control layer 217. Except for the above noted differences, the operation of this embodiment is the same as described above with respect to FIG. 1.

As a further alternative, instead of including the memory controller functionality in the host 210, the memory controller functionality may be included in the memory system 230.

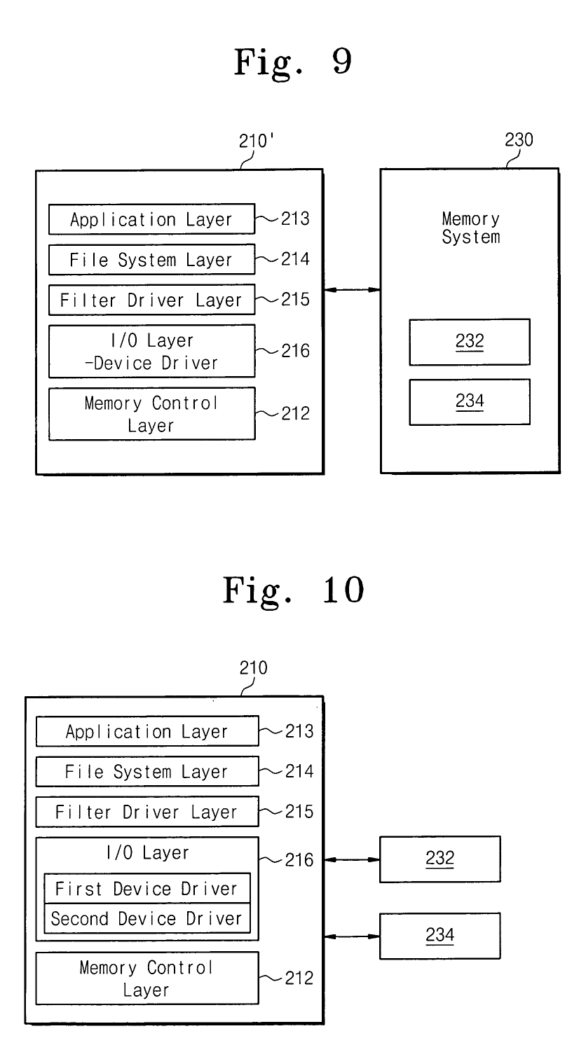

Referring to FIG. 10, this embodiment is the same as the embodiment of FIG. 9 except that the first and second types of memory 232 and 234 are not part of a single memory system. Instead, each memory 232 and 234 is a separately accessed and controlled memory. As a result, and as shown in FIG. 10, the input/output layer 216 includes a first device driver and a second device driver. Both device drivers receive the tag from the filter driver 215, but only the device driver associated with the selected memory 232 or 234 formats input/output layer information and includes the tag therein. Otherwise, the operation of this embodiment is the same as described in detail above.

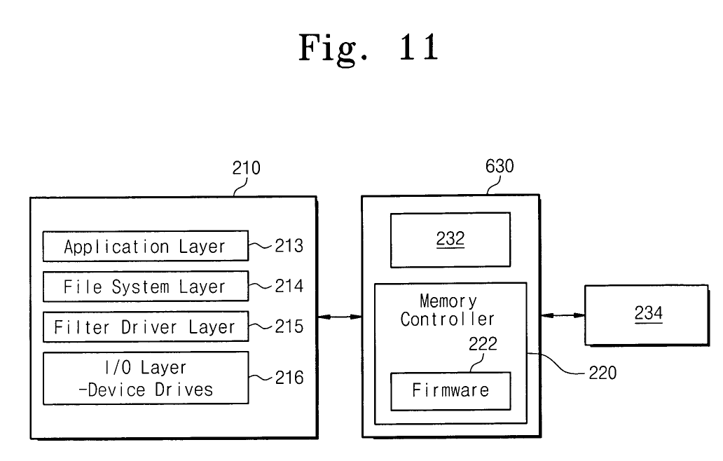

Referring to FIG. 11, this embodiment is the same as the embodiment of FIG. 1 except that the first type of memory 232 and the memory controller 220 form parts of a storage module 630, and the second type of memory 234 is a separate memory device. As will be appreciated, except for the above noted differences, operation of this embodiment is the same as described above.

The invention being thus described, it will be obvious that the same may be varied in many ways. Such variations are not to be regarded as a departure from the invention, and all such modifications are intended to be included within the scope of the invention.

We claim:

1. A method of managing data storage, comprising:
determining in which of a plurality of memory portions to store a received file based on received characterizing information characterizing content of the file.

2. The method of claim 1, wherein at least two of the plurality of memory portions are in a same memory.

3. The method of claim 1, wherein at least two of the plurality of memory portions are in different memories.

4. The method of claim 1, wherein each of the plurality of memory portions have different access speeds.

5. The method of claim 3, wherein the received characterizing information includes a name of the file.

6. The method of claim 4, wherein the received characterizing information includes a file name extension of the file.

7. The method of claim 4, wherein the received characterizing information includes a type of the file.

8. The method of claim 4, wherein the received characterizing information includes symbolic information representing the file.

9. The method of claim 4, wherein the received characterizing information includes at least one of a name of the file, a file name extension of the file, a type of the file, and symbolic information representing the file.

10. The method of claim 9, wherein the determining step comprises:
maintaining an association of a plurality of stored characterizing information with the plurality of memory portions such that each stored characterizing information is associated with one of the plurality of memory portions;
discriminating if the received characterizing information matches one of the plurality of stored characterizing information; and
selecting the memory portion associated with the matching stored characterizing information as the memory portion in which to store the received file if the received characterizing information matches one of the plurality of stored characterizing information.

11. The method of claim 10, further comprising:
receiving the received characterizing information from an application layer.

12. The method of claim 10, further comprising:
receiving the received characterizing information from a file system layer.

13. The method of claim 10, further comprising:
inserting a tag in input/output layer information for storing the received file, the tag identifying the selected memory.

14. The method of claim 13, further comprising:
receiving the received characterizing information from an application layer.

15. The method of claim 13, further comprising:
receiving the received characterizing information from a file system layer.

16. The method of claim 10, further comprising:
generating input/output layer output information for storing the received file that includes a command to store the received file in the selected memory portion.

17. The method of claim 16, further comprising:
receiving the received characterizing information from an application layer.

18. The method of claim 16, further comprising:
receiving the received characterizing information from a file system layer.

19. The method of claim 10, wherein the pluralities of memory portions include a first memory portion and a second memory portion, and the first memory portion and second memory portion are a single level memory cell memory portion and a multiple level memory cell memory portion, respectively.

20. The method of claim 10, wherein the pluralities of memory portions include a first memory portion and a second memory portion, the first memory portion having a faster access speed than the second memory portion, and the first memory portion is at least a portion of a volatile memory.

21. The method of claim 10, wherein the pluralities of memory portions include a first memory portion and a second memory portion, the first memory portion having a faster access speed than the second memory portion, and the first memory portion is at least a portion of a non-volatile memory.

22. The method of claim 10, wherein the pluralities of memory portions include a first memory portion and a second memory portion, the first memory portion having a faster access speed than the second memory portion, and the second memory portion is at least a portion of a disk drive.

23. The method of claim 9, wherein the determining step comprises:
monitoring access frequency of stored files based on the characterizing information associated with the stored files; and
selecting one of the plurality of memory portions based on the monitored access frequency and the received characterizing information.

24. The method of claim 23, wherein
the monitoring step counts a number of times stored files having same characterizing information are accessed from the plurality of memory portions; and
the selecting step selects one of the plurality of memory portions based on the count associated with the characterizing information matching the received characterizing information.

25. The method of claim 24, wherein the selecting step selects a memory portion having a faster access speed than a current memory portion storing the received file if the count associated with the characterizing information matching the received characterizing information exceeds a threshold value.

26. The method of claim 23, further comprising:
inserting a tag in input/output layer information for storing the received file, the tag identifying the selected memory portion.

27. The method of claim 23, wherein further comprising:
generating input/output layer output information for storing the received file that includes a command to store the received file in the selected memory portion.

28. The method of claim 22, further comprising:
receiving the received characterizing information from an application layer.

29. The method of claim 22, further comprising:
receiving the received characterizing information from a file system layer.

30. The method of claim 22, wherein the pluralities of memory portions include a first memory portion and a second memory portion, and the first memory portion and second memory portion are a single level memory cell memory portion and a multiple level memory cell memory portion, respectively.

31. The method of claim 22, wherein the pluralities of memory portions include a first memory portion and a second memory portion, the first memory portion having a faster access speed than the second memory portion, and the first memory portion is at least a portion of a volatile memory.

32. The method of claim 23, wherein the pluralities of memory portions include a first memory portion and a second memory portion, the first memory portion having a faster access speed than the second memory portion, and the first memory portion is at least a portion of a non-volatile memory.

33. The method of claim 23, wherein the pluralities of memory portions include a first memory portion and a second memory portion, the first memory portion having a faster access speed than the second memory portion, and the second memory portion is at least a portion of a disk drive.

34. A method of managing data storage, comprising:
receiving input/output information for storing a file, the input/output information including address information, a command and a tag; and
determining which one of a plurality of memory portions to store the file based on the tag.

35. The method of claim 34, wherein the tag is disposed in a spare area of the command.

36. The method of claim 34, wherein the tag is appended to the address information.

37. The method of claim 34, wherein at least two of the plurality of memory portions are in a same memory.

38. The method of claim 34, wherein at least two of the plurality of memory portions are in different memories.

39. A system for managing data storage, comprising:
a memory system including at least a first memory portion and a second memory portion; and
a host system, the host system determining in which of the first and second memory portions to store a file based on received characterizing information characterizing content of the file.

40. The method of claim 39, wherein the first and second memory portions are in a same memory.

41. The method of claim 39, wherein the first and second memory portions are in different memories.

42. The system of claim 39, wherein the memory system is a flash memory including a single level memory cell portion and a multiple level memory cell portion, and the first memory portion is the single level memory cell portion and the second memory portion is the multiple level memory cell portion.

43. The system of claim 42, further comprising:
a memory controller receiving data associated with the file and an indication of the determination by the host system, and storing the received data in the indicated one of the single and multiple level memory cell portions.

44. The system of claim 39, wherein the first memory portion has a faster access speed than the second memory portion, and the first memory portion is at least a portion of a volatile memory.

45. The system of claim 39, wherein the first memory portion has a faster access speed than the second memory portion, and the first memory portion is at least a portion of a non-volatile memory.

46. The system of claim 39, wherein the first memory portion has a faster access speed than the second memory portion, and the second memory portion is at least a portion of a disk drive.

47. The system of claim 46, wherein the first memory portion is at least a portion of a flash memory.

48. A system for managing data storage, comprising:
a first memory;
a second memory; and
a host system, the host system determining in which of the first and second memories to store a file based on received characterizing information characterizing content of the file.

49. The system of claim 48, wherein the host system includes an input/output layer having a single input/output driver for the first and second memories, the single input/output driver generating input/output information for storing data associated with the file based on the determination of the host system.

50. The system of claim 48, wherein the host system includes an input/output layer having a first input/output driver for the first memory and a second input/output driver for the second memory, the first and second input/output drivers for respectively storing data associated with the file based on the determination of the host system.

51. The system of claim 48, further comprising:
a module disposed between the host system and the second memory, the module include the first memory and a memory controller, the memory controller receiving data associated with the file and an indication of the determination by the host system, and storing the received data in the indicated one of the first and second memories.
